(19) United States
(12) Patent Application Publication
(10) Pub. No.: US 2020/0069066 A1
(43) Pub. Date: Mar. 5, 2020

(54) Smart induction charging type foldable multipurpose office/fitness chair

(71) Applicant: Wing Man TSE, Hong Kong (HK)

(72) Inventor: Wing Man TSE, Hong Kong (HK)

(21) Appl. No.: 16/167,509

(22) Filed: Oct. 22, 2018

(30) Foreign Application Priority Data
Aug. 30, 2018 (CN) 201811004569.X

(51) Int. Cl. A47C 9/00; H02J 50/10; A63B 23/16; A63B 23/04

(52) U.S. Cl. CPC A47C 9/002; H02J 50/10; A63B 2225/09; A63B 23/04; A63B 23/16

(57) ABSTRACT

The present invention relates to a smart induction charging type foldable multipurpose office/fitness chair comprising a seat frame, a hand exercise mechanism, a leg exercise mechanism, a control mechanism and a charging assembly. The seat frame comprises a buttocks support portion, a torso support portion and a head support portion. The buttocks support portion is provided with a first support rod and a second rod member. The head support portion is hinged to an adjustment plate. The hand exercise mechanism comprises a T-shaped handrail and a damping mechanism. The leg exercise mechanism comprises an inner sleeve, an outer sleeve, a tread plate, a roller and a T-shaped guide shaft. The charging assembly comprises a first coil, a first magnet, a second coil, a third coil and a second magnet. The present invention relates to a smart induction charging type foldable multipurpose office/fitness chair with a reasonable structure, which has the advantages of being simply constructed, convenient to use, multifunctional, safe and reliable, comfortable to use, etc., effectively solving the problem of employees not having time to exercise.

### FIELD OF THE INVENTION

The present invention relates to the field of smart home, in particular a smart induction charging type foldable multipurpose office/fitness chair.

BACKGROUND

Nowadays, people's awareness of health increases as the economy grows. An increasing number of people are keen on exercising. When exercising, they often use fitness chairs and fitness mats. The fitness mats are laid on the frame of the fitness chair with a fixed structure, and can only be used to provide cushioning and increase the comfort level. The function is relatively simple and can hardly meet people's needs for exercising. In addition, most people sit for a long time at work, which is not good for their health, and find it difficult to spare time to exercise after work. Exercising in the office will disturb other colleagues' work. Therefore, it is necessary to invent a multifunctional and easy-to-use smart induction charging type foldable multipurpose office/fitness chair which will not disturb other colleagues when used in the office.

### SUMMARY

The technical problem to be solved by the present invention is: to overcome the problems described above, provided is a smart induction charging type foldable multipurpose office/fitness chair with a reasonable structure, which has the advantages of being simply constructed, convenient to use, multifunctional, safe and reliable, comfortable to use, etc., effectively solving the problem of employees not having time to exercise. It can store the energy generated from exercising on the chair as electrical energy and provide backup auxiliary power for electronic products.

The technical solution adopted by the present invention to solve the technical problem is: a smart induction charging type foldable multipurpose office/fitness chair comprising a seat frame, a hand exercise mechanism, a leg exercise mechanism, a control mechanism and a charging assembly. The seat frame comprises a buttocks support portion, a torso support portion and a head support portion. A bottom of the buttocks support portion is vertically provided with a first support rod, and a hydraulic rod is hingedly disposed on the buttocks support portion.

A lower end of the torso support portion is hinged to the buttocks support portion, and is hinged to the hydraulic rod. A back of the torso support portion is provided with a second rod member. The second rod member is an I-shaped structure. An upper end of the second rod member is rotatably connected to a fixed ring fixedly disposed on the torso support portion. A lower end of the second rod member is connected to a hook. A back of the torso support portion is provided with an inverted T-shaped chute. The hook comprises a T-shaped slider disposed in the inverted T-shaped chute and a hook-shaped bump disposed on the T-shaped slider. An electric cylinder is fixedly disposed in the inverted T-shaped chute, and a spindle of the electric cylinder is connected to the T-shaped slider.

An upper end of the torso support portion is provided with a support plate having a hollow structure. The support plate is provided thereon with a first adjustment handle. An inner cavity of the support plate is slidably connected to an adjustment plate. The head support portion is hinged to the adjustment plate. The adjustment plate is provided thereon with a groove. An inner side of the groove is provided with a gear rack and a gear meshing with the gear rack. The gear is drivingly connected to the first adjustment handle.

The hand exercise mechanism comprises a T-shaped handrail and a damping mechanism. A lower end of the T-shaped handrail is hinged to the buttocks support portion. The damping mechanism comprises a first blocking plate, a housing, a second adjustment handle disposed on the housing, a torsion spring disposed in an inner cavity of the housing, a guide wheel and a rotating shaft. An end of the rotating shaft is connected to the second adjustment handle. The other end of the rotating shaft is provided with a sleeve. The rotating shaft is sleeved with a convex ring on the housing. An inner side of the sleeve and an outer side of the convex ring are respectively provided with a gear ring. The gear rings mesh with each other. An end of the torsion spring is connected to the rotating shaft through a tension sensor. The other end of the torsion spring passes through the housing and the guide wheel on the first blocking plate to connect to the T-shaped handrail. The second adjustment handle is provided thereon with a liquid crystal screen for displaying the spring force of the torsion spring.

The leg exercise mechanism comprises an inner sleeve, an outer sleeve, a tread plate, a roller, and a T-shaped guide shaft. The inner sleeve is sleeved with the outer sleeve. A lower end of the T-shaped guide shaft is connected to an inner cavity of the outer sleeve. An upper end of the T-shaped guide shaft extends into the inner sleeve. A spacing on the T-shaped guide shaft is sleeved with a plurality of springs and a plurality of magnetic guide sliders, and an opening of the inner sleeve is provided with a cover plate for blocking the opening of the inner sleeve. The tread plate and the roller are respectively disposed on the outer sleeve. An upper end of the inner sleeve is hinged to the buttocks support portion.

The charging assembly comprises a first coil disposed on the buttocks support portion, a first magnet disposed on a buttocks cushion, a second coil sleeving the outer sleeve, a third coil disposed in an inner cavity of the housing, and a plurality of second magnet fixedly disposed on a surface of the torsion spring.

Further, the first support rod is made of a hydraulic cylinder or a pneumatic cylinder.

Further, the support plate and torso support portion are of an integral construction.

Further, a back of the torso support portion is provided with a second blocking plate for supporting the second rod member.

Further, the buttocks support portion, the torso support portion and the head support portion are respectively provided thereon with a buttocks cushion, a torso cushion, and a head cushion.

Further, the torso cushion is provided with an airbag, and the airbag is connected to an external air supply device through an air valve.

Further, the control mechanism comprises a pressure sensor disposed in the buttocks cushion, a gyroscope disposed in the torso cushion, and a control box disposed on the first support rod. The control box is provided therein with a microcontroller, a battery and a power unit. The microcontroller is electrically connected to the battery, the power unit, the electric cylinder, the pressure sensor, the gyroscope, the tension sensor, the liquid crystal screen, the first coil, the second coil, and the third coil respectively.

Further, the power unit is a hydraulic cylinder or a cylinder, and the power unit is connected to the first support rod.

Further, the second rod member is made of a self-locking telescopic rod.

Further, the T-shaped handrail is provided thereon with an external port electrically connected to the microcontroller, and the external port is provided thereon with a rubber sleeve for waterproofing and dustproofing.

The advantageous effect of the present invention is: a smart induction charging type foldable multipurpose office/fitness chair comprising a seat frame, a hand exercise mechanism, a leg exercise mechanism, a control mechanism and a charging assembly. The seat frame comprises a buttocks support portion, a torso support portion and a head support portion. The buttocks support portion, the torso support portion and the head support portion are connected in an adjustable manner. While adjusted to achieve optimal comfort, the seat can be turned into a variety of exercise equipment.

The hand exercise mechanism, the leg exercise mechanism and the charging assembly can not only exercise the body, but also convert the energy emitted from exercising into electrical energy, and can supply power to external electrical devices. Having a high degree of intelligence, the control mechanism can automatically adjust the operation according to the working state of the seat to improve the comfort level of the seat. It is of a reasonable structure, and has the advantages of being simply constructed, convenient to use, multifunctional, safe and reliable, comfortable to use, etc., effectively solving the problem of employees not having time to exercise.

### BRIEF DESCRIPTION OF THE DRAWINGS

The invention will now be further described with reference to the drawings and embodiments.

FIG. 1 is a schematic diagram showing the overall structure of the smart induction charging type foldable multipurpose office/fitness chair of the present invention in a folded state;

FIG. 2 is a schematic diagram showing the overall structure of the smart induction charging type foldable multipurpose office/fitness chair of the present invention in a deployed state;

FIG. 3 is a schematic diagram showing the back structure of the smart induction charging type foldable multipurpose office/fitness chair of the present invention;

FIG. 4 is a schematic diagram showing the structure the damping mechanism of the smart induction charging type foldable multipurpose office/fitness chair of the present invention;

FIG. 5 is a schematic diagram showing the cross-sectional structure of the damping mechanism of the smart induction charging type foldable multipurpose office/fitness chair of the present invention;

FIG. 6 is a schematic diagram showing the connecting structure of the torso support portion and the head support portion of the smart induction charging type foldable multipurpose office/fitness chair of the present invention;

FIG. 7 is a schematic diagram showing the structure of the hook of the smart induction charging type foldable multipurpose office/fitness chair of the present invention;

FIG. 8 is a schematic diagram showing the connecting structure of the hook and the torso support portion of the smart induction charging type foldable multipurpose office/fitness chair of the present invention;

FIG. 9 is a schematic diagram showing the cross-sectional structure of the leg exercise mechanism of the smart induction charging type foldable multipurpose office/fitness chair of the present invention;

FIG. 10 is a schematic diagram showing the cross-sectional connecting structure of the buttocks support portion and the buttocks cushion of the smart induction charging type foldable multipurpose office/fitness chair of the present invention;

The labels in the drawings are as follows: (1) seat frame, (11) first support rod, (111) non-slip mat, (12) buttocks support portion, (121) buttocks cushion, (122) first coil, (123) first magnet, (13) torso support portion, (131) torso cushion, (132) airbag, (133) air valve, (134) inverted T-shaped chute, (14) head support portion, (141) head cushion, (15) hydraulic rod, (16) adjustment plate, (161) support plate, (162) first adjustment handle, (163) groove, (164) gear, (165) gear rack, (17) second rod member, (171) fixed ring, (172) second blocking plate, (173) hook, (1731) T-shaped slider, (1732) hook-shaped bump, (2) hand exercise mechanism, (21) T-shaped handrail, (211) external port, (22) damping mechanism, (221) second adjustment handle, (222) first blocking plate, (223) housing, (2231) convex ring, (2232) gear ring, (2233) third coil, (224) torsion spring, (2241) second magnet, (225) guide wheel, (226) rotating shaft, (2261) sleeve, (3) leg exercise mechanism, (31) inner sleeve, (32) outer sleeve, (33) tread plate, (34) roller, (35) T-shaped guide shaft, (351) spring, (352) guide slider, (36) second coil, (4) control mechanism, (41) pressure sensor, (42) gyroscope, (43) control box, (431) microcontroller, (432) battery, (433) power unit, (44) electric cylinder.

### DETAILED DESCRIPTION

The invention will now be described in further detail with reference to the drawings. The drawings are simplified schematic diagrams. The basic structure of the present invention is illustrated merely in a schematic manner.

Therefore, only the configurations related to the present invention are shown.

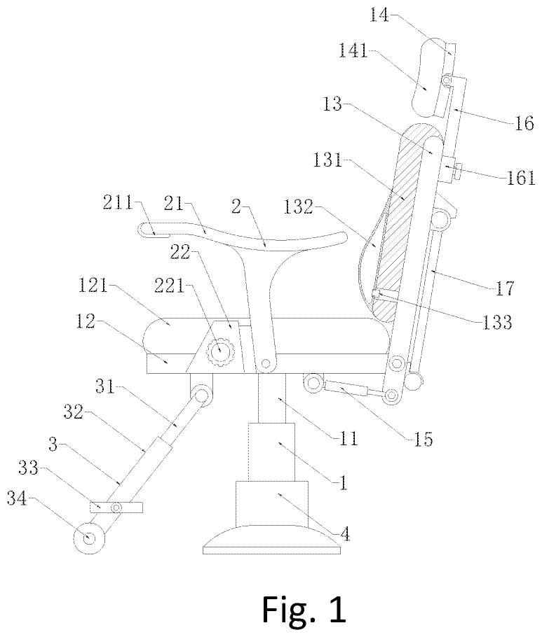

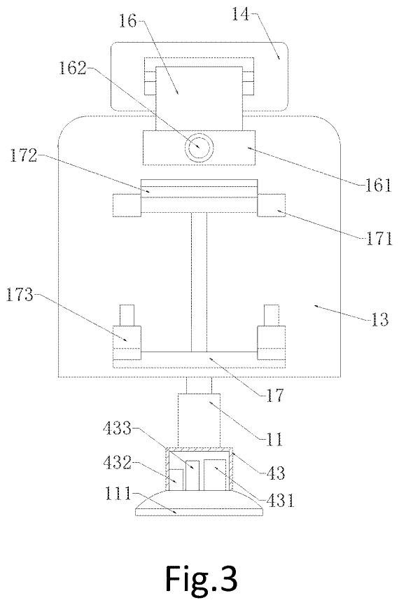

As shown in FIGS. 1, 2 and 3, a smart induction charging type foldable multipurpose office/fitness chair comprises a seat frame 1, a hand exercise mechanism 2, a leg exercise mechanism 3, a control mechanism 4 and a charging assembly. The seat frame 1 comprises a buttocks support portion 12, a torso support portion 13 and a head support portion 14. A bottom of the buttocks support portion 12 is vertically provided with a first support rod 11, and a hydraulic rod 15 is hingedly disposed on the buttocks support portion 12. In an embodiment, a bottom of the first support rod 11 is provided with a non-slip mat 111.

A lower end of the torso support portion 13 is hinged to the buttocks support portion 12, and is hinged to the hydraulic rod 15. The hydraulic rod 15 is used for preventing the buttocks support portion 12 from rotating relative to the torso support portion 13 when the force received by the torso support portion 13 is within a certain range of values. When the force received by the torso support portion 13 exceeds the certain range of values, the buttocks support portion 12 and the torso support portion 13 will be rotated relative to each other and deployed.

A back of the torso support portion 13 is provided with a second rod member 17. In an embodiment, the second rod member 17 is an I-shaped structure.

An upper end of the second rod member 17 is rotatably connected to a fixed ring 171 fixedly disposed on the torso support portion 13. A lower end of the second rod member 17 is connected to a hook 173.

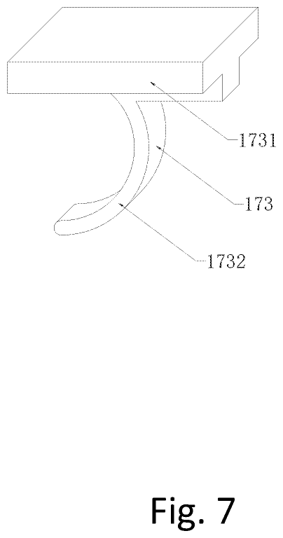

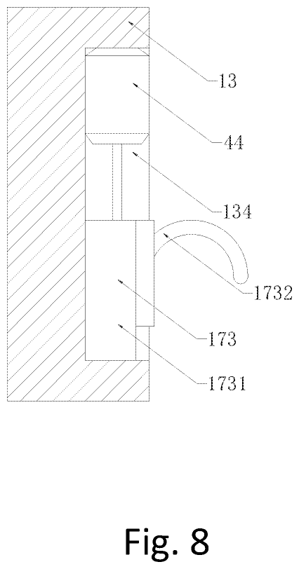

As shown in FIGS. 7 and 8, in an embodiment, a back of the torso support portion 13 is provided with an inverted T-shaped chute 134. The hook 173 comprises a T-shaped slider 1731 disposed in the inverted T-shaped chute 134 and a hook-shaped bump 1732 disposed on the T-shaped slider 1731. An electric cylinder 44 is fixedly disposed in the inverted T-shaped chute 134, and a spindle of the electric cylinder 44 is connected to the T-shaped slider 1731.

An upper end of the torso support portion 13 is provided with a support plate 161 having a hollow structure. The support plate 161 is provided with a first adjustment handle 162.

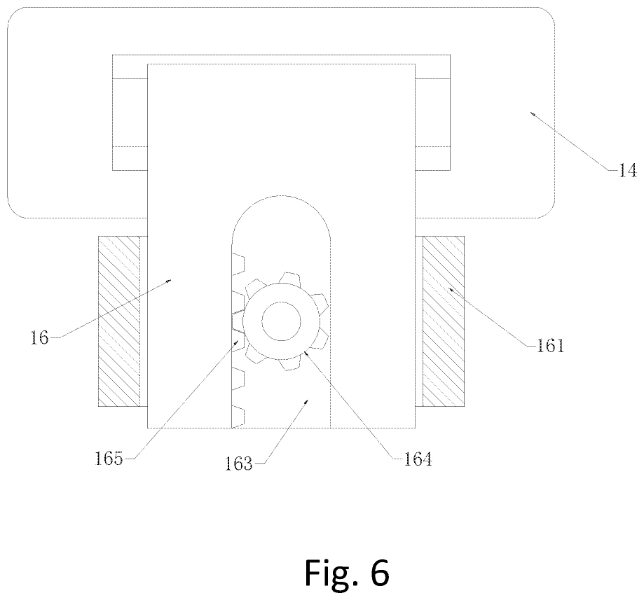

As shown in FIG. 6, an inner cavity of the support plate 161 is slidably connected to an adjustment plate 16. The head support portion 14 is hinged to the adjustment plate 16. In an embodiment, the adjustment plate 16 is provided thereon with a groove 163. An inner side of the groove 163 is provided with a gear rack 165 and a gear 164 meshing with the gear rack 165.

The gear 164 is drivingly connected to the first adjustment handle 162. By rotating the first adjustment handle 162 to drive the gear 164, the adjustment plate 16 is moved up and down to adjust the height of the head support portion 14.

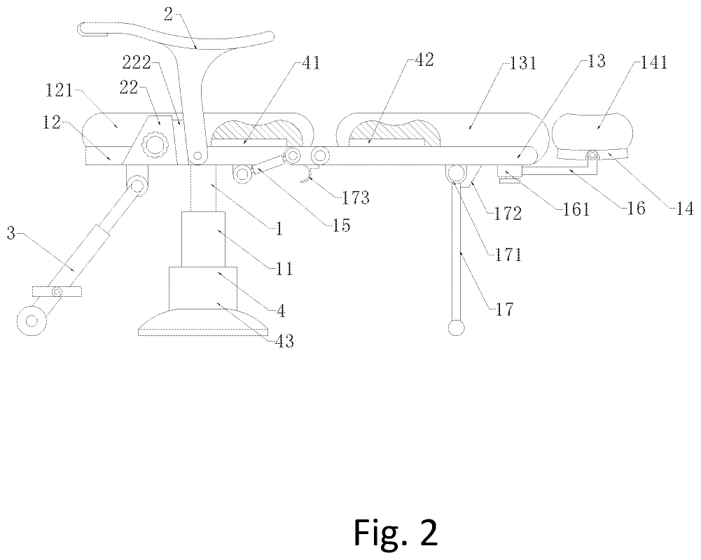

As shown in FIGS. 1 and 2, the hand exercise mechanism 2 comprises a T-shaped handrail 21 and a damping mechanism 22. A lower end of the T-shaped handrail 21 is hinged to the buttocks support portion 12 by a hinge shaft.

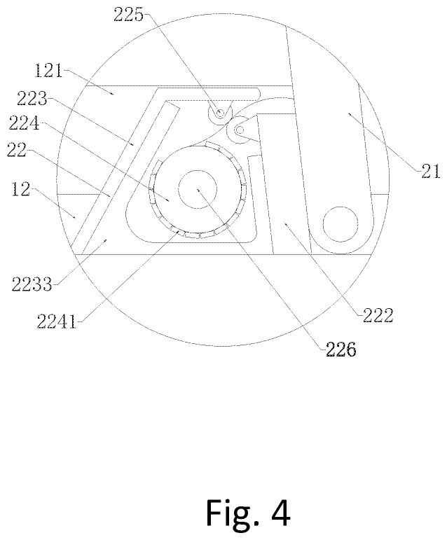

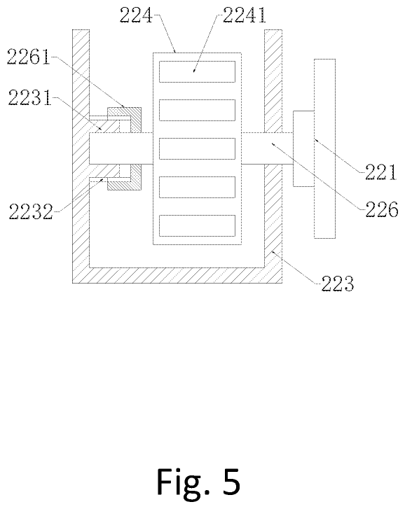

As shown in FIGS. 4 and 5, the damping mechanism 22 comprises a first blocking plate 222, a housing 223, a second adjustment handle 221 disposed on the housing 223, a torsion spring 224 disposed in an inner cavity of the housing 223, a guide wheel 225 and a rotating shaft 226. An end of the rotating shaft 226 is connected to the second adjustment handle 221. The other end of the rotating shaft 226 is provided with a sleeve 2261. The rotating shaft 226 is sleeved with a convex ring 2231 on the housing 223. An inner side of the sleeve 2261 and an outer side of the convex ring 2231 are respectively provided with a gear ring 2232, and the gear rings 2232 mesh with each other. The rotating shaft 226 is pulled outward by the second adjustment handle 221, so that the gear rings 2232 are separated from each other. The rotating shaft 226 is rotated until appropriately adjusted and then the rotating shaft 226 is pushed inward so that the gear rings 2232 remesh.

An end of the torsion spring 224 is connected to the rotating shaft 226 through a tension sensor. The other end of the torsion spring 224 passes through the housing 223 and the guide wheel 225 on the first blocking plate 222 to connect to the T-shaped handrail 21. The second adjustment handle 221 is provided thereon with a liquid crystal screen for displaying the spring force of the torsion spring 224. In an embodiment, the liquid crystal screen represents the spring force of the torsion spring 224 by displaying different colors.

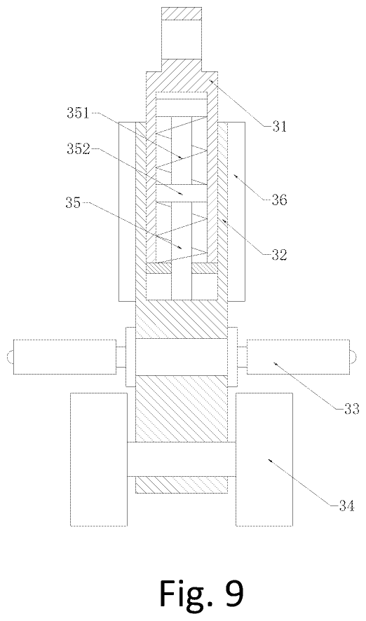

As shown in FIG. 9, the leg exercise mechanism 3 comprises an inner sleeve 31, an outer sleeve 32, a tread plate 33, a roller 34 and a T-shaped guide shaft 35. The inner sleeve 31 is sleeved with the outer sleeve 32. A lower end of the T-shaped guide shaft 35 is connected to an inner cavity of the outer sleeve 32. An upper end of the T-shaped guide shaft 35 extends into the inner sleeve 31. A spacing on the T-shaped guide shaft 35 is sleeved with a plurality of springs 351 and a plurality of magnetic guide sliders 352, and an opening of the inner sleeve 31 is provided with a cover plate for blocking the opening of the inner sleeve 31. The tread plate 33 and the roller 34 are respectively disposed on the outer sleeve 32. An upper end of the inner sleeve 31 is hinged to the buttocks support portion 12.

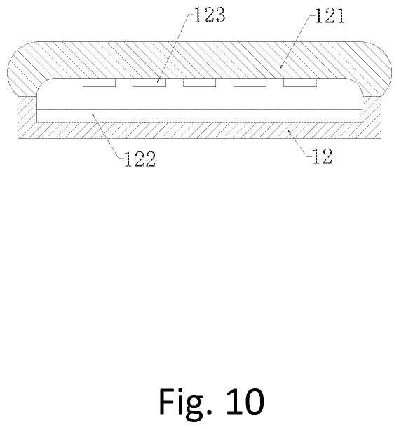

As shown in FIGS. 4, 9 and 10, the charging assembly comprises a first coil 122 disposed on the buttocks support portion 12, a first magnet 123 disposed on a buttocks cushion 121, a second coil 36 sleeving the outer sleeve 32, a third coil 2233 disposed in an inner cavity of the housing 223, and a plurality of second magnet 2241 fixedly disposed on a surface of the torsion spring 224.

The first coil 122 and the first magnet 123 cooperate with each other, the second coil 36 and the guide slider 352 cooperate with each other, and the second magnet 2241 and the third coil 2233 cooperate with each other to generate electric energy by the “electromagnetic induction” principle.

In an embodiment, the first support rod 11 is made of a hydraulic cylinder or a pneumatic cylinder.

In an embodiment, the support plate 161 and the torso support portion 13 are of an integral construction.

In an embodiment, a back of the torso support portion 13 is provided with a second blocking plate 172 for supporting the second rod member 17. The second blocking plate 172 is provided thereon a catch slot for catching the second rod member 17.

The buttocks support portion 12, the torso support portion 13 and the head support portion 14 are respectively provided thereon with a buttocks cushion 121, a torso cushion 131, and a head cushion 141.

In an embodiment, the torso cushion 131 is provided thereon with an airbag 132, and the airbag 132 is connected to an external air supply device through an air valve 133. The airbag 132 is used for adjusting the fit degree of the seat to the waist of the human body. The external air supply device may be a manual air pump or an electric air pump.

The control mechanism 4 comprises a pressure sensor 41 disposed in the buttocks cushion 121, a gyroscope 42 disposed in the torso cushion 131, and a control box 43 disposed on the first support rod 11. The pressure sensor 41 is used for detecting whether a person is sitting on the chair. The gyroscope 42 is used for detecting the inclination angle of the torso support portion 13.

The control box 43 is provided therein with a microcontroller 431, a battery 432 and a power unit 433. The microcontroller 431 is electrically connected to the battery 432, the power unit 433, the electric cylinder 44, the pressure sensor 41, the gyroscope 42, the tension sensor, the liquid crystal screen, the first coil 122, the second coil 36, and the third coil 2233 respectively. When the gyroscope 42 detects that the inclination angle of the torso support portion 13 is within a set range of values, the microcontroller 431 will control the electric cylinder 44 to lift the hook 173 and lower the second rod member 17 to prevent the seat from tipping over. The electric energy generated in the first coil 122, the second coil 36 and the third coil 2233 is stored in the battery 432 after being processed by the microcontroller 431.

In an embodiment, the power unit 433 is a hydraulic cylinder or a cylinder, and the power unit 433 is connected to the first support rod 11.

In an embodiment, the second rod member 17 is a self-locking telescopic rod.

In another embodiment, the second rod member 17 is a hydraulic cylinder or a pneumatic cylinder.

In an embodiment, the T-shaped handrail 21 is provided with an external port 211 electrically connected to the microcontroller 431, and the external port 211 is provided thereon with a rubber sleeve for waterproofing and dustproofing. The external port 211 should have a data transmission or power output function, or have both data transmission and power output functions.

The smart induction charging type foldable multipurpose office/fitness chair of the present invention comprises a seat frame, a hand exercise mechanism, a leg exercise mechanism, a control mechanism and a charging assembly. The seat frame comprises a buttocks support portion, a torso support portion and a head support portion. The buttocks support portion, the torso support portion and the head support portion are connected in an adjustable manner.

While adjusted to achieve optimal comfort, the seat can be turned into a variety of exercise equipment. The hand exercise mechanism, the leg exercise mechanism and the charging assembly can not only exercise the body, but also convert the energy emitted from exercising into electrical energy, and can supply power to external electrical devices. Having a high degree of intelligence, the control mechanism can automatically adjust the operation according to the working state of the seat to improve the comfort level of the seat. It is of a reasonable structure, and has the advantages of being simply constructed, convenient to use, multifunctional, safe and reliable, comfortable to use, etc., effectively solving the problem of employees not having time to exercise.

In view of the above-described embodiments of the present invention, various changes and modifications can be made by those skilled in the art without departing from the scope of the present invention. The technical scope of the present invention is not limited to the contents of the specification. The technical scope thereof must be determined according to the scope of the claims.

1. A smart induction charging type foldable multipurpose office/fitness chair, characterized in that: comprising a seat frame (1), a hand exercise mechanism (2), a leg exercise mechanism (3), a control mechanism (4) and a charging assembly, the seat frame (1) comprising a buttocks support portion (12), a torso support portion (13) and a head support portion (14); a bottom of the buttocks support portion (12) is vertically provided with a first support rod (11), and a hydraulic rod (15) is hingedly disposed on the buttocks support portion (12);
a lower end of the torso support portion (13) is hinged to the buttocks support portion (12), and is hinged to the hydraulic rod (15); a back of the torso support portion (13) is provided with a second rod member (17), the second rod member (17) being an I-shaped structure, an upper end of the second rod member (17) rotatably connected to a fixed ring (171) fixedly disposed on the torso support portion (13) , a lower end of the second rod member (17) connected to a hook (173); a back of the torso support portion (13) is provided with an inverted T-shaped chute (134), the hook (173) comprising a T-shaped slider (1731) disposed in the inverted T-shaped chute (134) and a hook-shaped bump (1732) disposed on the T-shaped slider (1731); an electric cylinder (44) is fixedly disposed in the inverted T-shaped chute (134), and a spindle of the electric cylinder (44) is connected to the T-shaped slider (1731);
an upper end of the torso support portion (13) is provided with a support plate (161) having a hollow structure, the support plate (161) provided thereon with a first adjustment handle (162); an inner cavity of the support plate (161) is slidably connected to an adjustment plate (16), the head support portion (14) hinged to the adjustment plate (16); the adjustment plate (16) is provided thereon with a groove (163), an inner side of the groove (163) provided with a gear rack (165) and a gear (164) meshing with the gear rack (165), the gear (164) drivingly connected to the first adjustment handle (162);
the hand exercise mechanism (2) comprises a T-shaped handrail (21) and a damping mechanism (22); a lower end of the T-shaped handrail (21) is hinged to the buttocks support portion (12); the damping mechanism (22) comprises a first blocking plate (222), a housing (223), a second adjustment handle (221) disposed on the housing (223), a torsion spring (224) disposed in an inner cavity of the housing (223), a guide wheel (225) and a rotating shaft (226); an end of the rotating shaft (226) is connected to the second adjustment handle (221), the other end of the rotating shaft (226) provided with a sleeve (2261), the rotating shaft (226) sleeved with a convex ring (2231) on the housing (223), an inner side of the sleeve (2261) and an outer side of the convex ring (2231) respectively provided with a gear ring (2232), the gear rings (2232) meshing with each other; an end of the torsion spring (224) is connected to the rotating shaft (226) through a tension sensor, the other end of the torsion spring (224) passing through the housing (223) and the guide wheel (225) on the first blocking plate (222) to connect to the T-shaped handrail (21); the second adjustment handle (221) is provided thereon with a liquid crystal screen for displaying the spring force of the torsion spring (224);
the leg exercise mechanism (3) comprises an inner sleeve (31), an outer sleeve (32), a tread plate (33), a roller (34), and a T-shaped guide shaft (35), the inner sleeve (31) sleeved with the outer sleeve (32); a lower end of the T-shaped guide shaft (35) is connected to an inner cavity of the outer sleeve (32), an upper end of the T-shaped guide shaft (35) extending into the inner sleeve (31), a spacing on the T-shaped guide shaft (35) sleeved with a plurality of springs (351) and a plurality of magnetic guide sliders (352), an opening of the inner sleeve (31) provided with a cover plate for blocking the opening of the inner sleeve (31); the tread plate (33) and the roller (34) are respectively disposed on the outer sleeve (32); an upper end of the inner sleeve (31) is hinged to the buttocks support portion (12);
the charging assembly comprises a first coil (122) disposed on the buttocks support portion (12), a first magnet (123) disposed on a buttocks cushion (121), a second coil (36) sleeving the outer sleeve (32), a third coil (2233) disposed in an inner cavity of the housing (223), and a plurality of second magnets (2241) fixedly disposed on a surface of the torsion spring (224);

2. The smart induction charging type foldable multipurpose office/fitness chair according to claim 1, characterized in that: the first support rod (11) is made of a hydraulic cylinder or a pneumatic cylinder.

3. The smart induction charging type foldable multipurpose office/fitness chair according to claim 1, characterized in that: the support plate (161) and the torso support portion (13) are of an integral construction.

4. The smart induction charging type foldable multipurpose office/fitness chair according to claim 1, characterized in that: a back of the torso support portion (13) is provided with a second blocking plate (172) for supporting the second rod member (17).

5. The smart induction charging type foldable multipurpose office/fitness chair according to claim 1, characterized in that: the buttocks support portion (12), the torso support portion (13) and the head support portion (14) are respectively provided thereon with a buttocks cushion (121), a torso cushion (131), and a head cushion (141).

6. The smart induction charging type foldable multipurpose office/fitness chair according to claim 5, characterized in that: the torso cushion (131) is provided thereon with an airbag (132), the airbag (132) connected to an external air supply device through an air valve (133).

7. The smart induction charging type foldable multipurpose office/fitness chair according to claim 5, characterized in that: the control mechanism (4) comprises a pressure sensor (41) disposed in the buttocks cushion (121), a gyroscope (42) disposed in the torso cushion (131), and a control box (43) disposed on the first support rod (11); the control box (43) is provided therein with a microcontroller (431), a battery (432) and a power unit (433), the microcontroller (431) electrically connected to the battery (432), the power unit (433), the electric cylinder (44), the pressure sensor (41), the gyroscope (42), the tension sensor, the liquid crystal screen, the first coil (122), the second coil (36), and the third coil (2233) respectively.

8. The smart induction charging type foldable multipurpose office/fitness chair according to claim 7, characterized in that: the power unit (433) is a hydraulic cylinder or a cylinder, and the power unit (433) is connected to the first support rod (11).

9. The smart induction charging type foldable multipurpose office/fitness chair according to claim 1, characterized in that: the second rod member (17) is made of a self-locking telescopic rod.

10. The smart induction charging type foldable multipurpose office/fitness chair according to claim 1, characterized in that: the T-shaped handrail (21) is provided thereon with an external port (211) electrically connected to the microcontroller (431), and the external port (211) is provided thereon with a rubber sleeve for waterproofing and dustproofing.
